(19) United States
(12) Patent Application Publication
(10) Pub. No.: US 2025/0132471 A1
(43) Pub. Date: Apr. 24, 2025

(54) BATTERY AND MODULE

(71) Applicant: TOYOTA JIDOSHA KABUSHIKI KAISHA, Toyota-shi (JP)

(72) Inventors: Kota OHATA, Toyota-shi (JP); Masahiro ISHIZUKA, Toyota-shi (JP); Hajime HASEGAWA, Aichi-gun (JP); Mitsuru TATEISHI, Toyota-shi (JP); Norihiro OSE, Nagoya-shi (JP); Masashi CHIHARA, Nagoya-shi (JP)

(21) Appl. No.: 18/826,187

(22) Filed: Sep. 6, 2024

(30) Foreign Application Priority Data
Oct. 24, 2023 (JP) 2023-182593

(51) Int. Cl. H01M 50/54; H01M 4/62; H01M 50/105; H01M 50/593

(52) U.S. Cl. CPC H01M 50/54; H01M 4/623; H01M 50/105; H01M 50/593

(57) ABSTRACT

A battery includes: a layer-type electrode body including a positive electrode sheet and a negative electrode sheet, the positive negative electrode sheets being alternately layered in a layering direction via a separator sheet; a laminate exterior body accommodating the electrode body; a positive electrode tab that projects from the laminate exterior body toward a first direction orthogonal to the layering direction, and that is electrically connected to the positive electrode sheets; a negative electrode tab that projects from the laminate exterior body toward another side in the first direction, and that is electrically connected to the negative electrode sheets; and an electrically insulating layer, wherein: the positive electrode current collector includes a positive electrode lead part, the electrically insulating layer is disposed at a surface of the positive electrode lead part, and the electrically insulating layer includes a binder and an electrically insulating filler.

### CROSS-REFERENCE TO RELATED APPLICATION

This application is based on and claims priority under 35 USC 119 from Japanese Patent Application No. 2023-182593, filed on Oct. 24, 2023, the entire disclosure of which is incorporated by reference herein.

### BACKGROUND

### Technical Field

The present disclosure relates to a battery and a module.

### Related Art

Japanese Patent Application Laid-open (JP-A) No. 2015-60626 discloses a lithium-ion secondary battery (hereinafter, also referred to as a “battery”). The battery has an electrode body in which a positive electrode and a negative electrode are layered via a separator, and a nonaqueous electrolyte. The positive electrode has a main body and a narrow part (hereinafter, also referred to as a “positive electrode lead part”) which has a smaller width than the main body and which forms a current collection tab, protruding from the main body in plan view. A positive electrode mixture layer is formed on one surface or both surfaces of a current collector in the main body of the positive electrode. The positive electrode mixture layer contains a positive electrode active material. The positive electrode mixture layer is not formed on the current collector in at least a part of the positive electrode lead part of the positive electrode. The negative electrode has a main body and a narrow part (hereinafter, also referred to as a “negative electrode lead part”) which has a smaller width than the main body and which forms a current collection tab, protruding from the main body in plan view. A negative electrode mixture layer is formed on one surface or both surfaces of a current collector in the main body of the negative electrode. The negative electrode mixture layer contains a negative electrode active material. The negative electrode mixture layer is not formed on the current collector in at least a part of the negative electrode lead part of the negative electrode. A short circuit prevention layer is formed on the current collector at least at a part of the positive electrode lead part of the positive electrode which faces the negative electrode mixture layer of the negative electrode via the separator. As a short-circuit prevention layer, a resin having a cross-linked structure in at least a part thereof has been disclosed. The short-circuit prevention layer can be obtained by irradiating an energy ray onto an oligomer that is polymerizable by irradiation with an energy ray.

When charging and discharging of the battery are alternately performed, the positive electrode lead part tends to generate heat. Therefore, the short-circuit prevention layer disclosed in JP-A No. 2015-60626 is likely to be exposed to a high-temperature environment. As a result, owing to creep, the film thickness of the short-circuit prevention layer tends to be reduced over time. “Creep” refers to a phenomenon in which a material deforms over time under a constant stress or load. As a result, there is a risk that the short-circuit prevention layer will lose the function of preventing a short circuit between the positive electrode and the negative electrode. In other words, a short circuit between the positive electrode and the negative electrode may occur.

### SUMMARY

The present disclosure has been made in view of the above circumstances. The present disclosure is to provide a battery and a module in which the occurrence of short circuiting is suppressed.

A battery of a first aspect of the present disclosure includes:
a layer-type electrode body including a positive electrode sheet including a positive electrode current collector and a negative electrode sheet including a negative electrode current collector, the positive electrode sheet and the negative electrode sheet being alternately layered in a layering direction via a separator sheet;
a laminate exterior body accommodating the electrode body;
a positive electrode tab that projects from the laminate exterior body toward one side in a first direction orthogonal to the layering direction, and that is electrically connected to a plurality of the positive electrode sheets;
a negative electrode tab that projects from the laminate exterior body toward the one side or another side in the first direction, and that is electrically connected to a plurality of the negative electrode sheets; and
an electrically insulating layer, wherein
the positive electrode current collector includes a positive electrode lead part, which is a component of the positive electrode tab,
the electrically insulating layer being disposed at a surface of the positive electrode lead part, and
the electrically insulating layer including a binder and an electrically insulating filler.

A “layer-type electrode body” refers to a battery in which each of a positive electrode sheet, a negative electrode sheet, and a separator sheet has a single-wafer shape (i.e., a sheet form), and the positive electrode sheet and the negative electrode sheet are alternately layered via the separator sheet.

A “laminate exterior body” refers to a case made of a laminate sheet. A “laminate sheet” refers to a sheet having a metal layer, a first resin layer layered on one main surface of the metal layer, and a second resin layer layered on the other main surface of the metal layer.

An “electrically insulating layer” refers to a layer having an electrical resistivity of 10¹⁰ Ω·m or more.

A “positive electrode lead part, which is a component of the positive electrode tab”, includes a positive electrode lead part that is the positive electrode tab and a positive electrode lead part that is a separate member from the positive electrode tab.

In the first aspect, the electrically insulating layer includes a binder and an electrically insulating filler. As a result, even if the thickness of the electrically insulating layer decreases with time after the electrically insulating layer is exposed to a high temperature, the thickness of the electrically insulating layer is unlikely to become thinner than the average particle diameter of the electrically insulating filler. In other words, the function of the electrically insulating layer of providing electrical insulation to the positive electrode lead part is unlikely to be degraded by heat. As a result, in the battery of the first aspect, the occurrence of short circuiting is suppressed.

A battery of a second aspect of the present disclosure is the battery of the first aspect, in which the binder includes polyvinylidene fluoride.

In general, polyvinylidene fluoride tends not to generate a different reaction from the battery reaction even if charging and discharging of the battery are alternately performed. As a result, the capacity of the battery of the second aspect is less likely to decrease than in a configuration in which the binder does not contain polyvinylidene fluoride. Furthermore, the electrically insulating layer of the battery of the second aspect has better thermal stability than a configuration in which the binder does not contain polyvinylidene fluoride.

A battery of a third aspect of the present disclosure is the battery of the first or second aspect, in which the electrically insulating filler includes at least one of alumina beads or zirconia beads.

As a result, in the battery of the third aspect, the occurrence of short circuiting is suppressed more than in a configuration in which the electrically insulating filler does not contain alumina beads or zirconia beads.

A battery of a fourth aspect of the present disclosure is the battery of any of the foregoing aspects, in which an average particle diameter of the electrically insulating filler is from about 1 μm to about 5 μm.

As a result, the thickness of the electrically insulating layer is unlikely to become large, and the thickness of the electrically insulating layer is unlikely to become substantially less than 1 μm as a result of creep. As a result, in the battery of the fourth aspect, even if the thickness of the electrically insulating layer is relatively thin, the occurrence of short circuiting is more reliably suppressed.

A module of a fifth aspect of the present disclosure includes:
the battery of any one of the foregoing aspects; and
a case housing a plurality of the batteries.

According to the present disclosure, a battery and a module are provided in which the occurrence of short circuiting is suppressed.

### BRIEF DESCRIPTION OF THE DRAWINGS

Exemplary embodiments of the present disclosure will be described in detail based on the following figures, wherein:

FIG. 1 is a perspective view of a module of an embodiment of the present disclosure;

FIG. 2 is a top view of a module according to an embodiment of the present disclosure in a state in which a case lid has been removed;

FIG. 3 is a front view of a battery according to an embodiment of the present disclosure; and

FIG. 4 is a cross-sectional view taken along line IV-IV of FIG. 3.

### DETAILED DESCRIPTION

Hereinafter, embodiments of the present disclosure will be described. These descriptions and examples illustrate embodiments and do not limit the scope of the embodiments.

In the present disclosure, a combination of two or more preferred embodiments is a more preferable embodiment.

In the present disclosure, a numerical range expressed using “to” means a range in which the numerical values described before and after “to” are included as the lower limit value and the upper limit value.

In numerical ranges given in a stepwise manner in the present disclosure, the upper limit or lower limit given in one numerical range may be replaced with the upper limit or lower limit given in another stepwise description of a numerical range. In the numerical ranges set forth in the present disclosure, the upper or lower limit of the numerical range may be replaced with a value set forth in the examples.

Hereinafter, embodiments of a battery and a module of the present disclosure will be described with reference to the drawings. In the drawings, the same or corresponding parts are denoted by the same reference numerals, and description thereof is not repeated.

### (1) Module

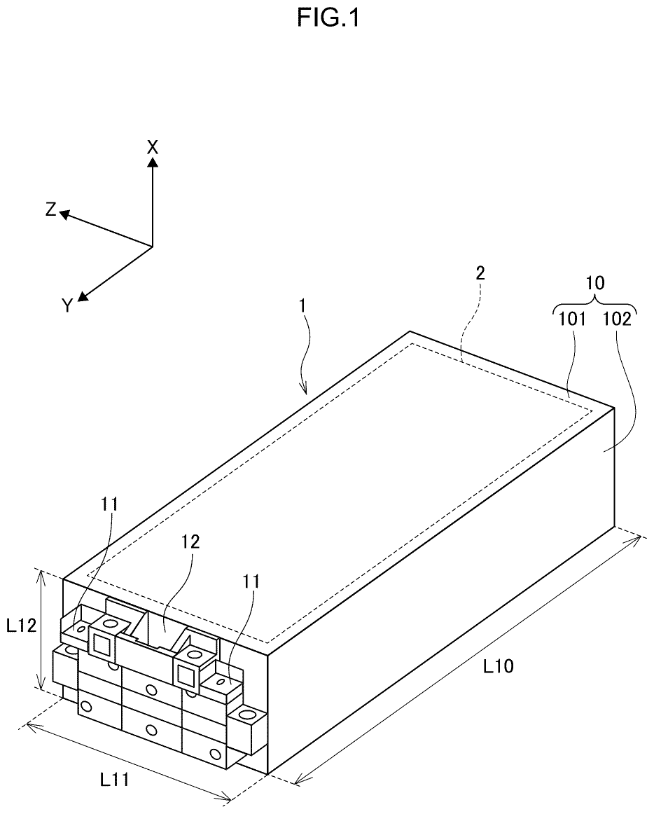

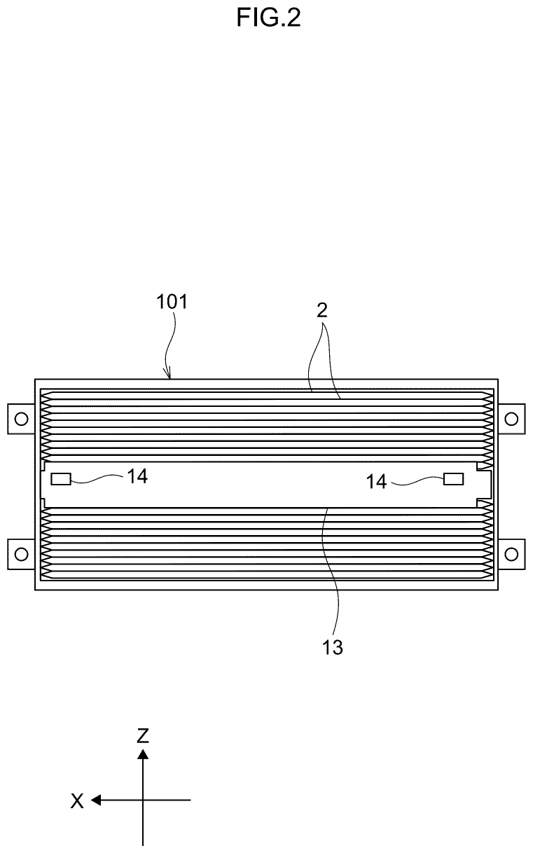

As shown in FIGS. 1 and 2, a module 1 according to an embodiment of the present disclosure includes plural batteries 2 and a case 10. The case 10 houses plural batteries 2. The module 1 has a rectangular parallelepiped shape.

In the present embodiment, the thickness direction of the module 1 is defined as the X-axis direction, the longitudinal direction of the main surface of the module 1 is defined as the Y-axis direction, and the transverse direction of the module 1 is defined as the Z-axis direction. The X-axis, the Y-axis, and the Z-axis are respectively orthogonal to each other. The X-axis direction is an example of a second direction. The X-axis positive direction is an example of an upper direction. The Y-axis direction is an example of a first direction. The Z-axis direction is an example of a layering direction. Note that these orientations do not limit the orientation of the battery and the module of the present disclosure when used.

The length L10 of the module 1 in the Y-axis direction is, for example, 350 mm to 600 mm. The length L11 of the module 1 in the Z-axis direction is, for example, 150 mm to 250 mm. The length L12 of the module 1 in the X-axis direction is, for example, 80 mm to 110 mm.

A pair of voltage terminals 11 and a connector 12 are provided at each end of the module 1 in the Y-axis direction. A flexible printed board 13, which will be described later, is connected to the connector 12. A bus bar (not illustrated) is welded to both ends of the module 1 in the Y-axis direction.

The case 10 has a case body 101 and a case lid 102. The case 10 is formed of an aluminum alloy. The case 10 is formed, for example, by joining aluminum die-casting to both end parts of an extruded material of an aluminum alloy by laser welding or the like.

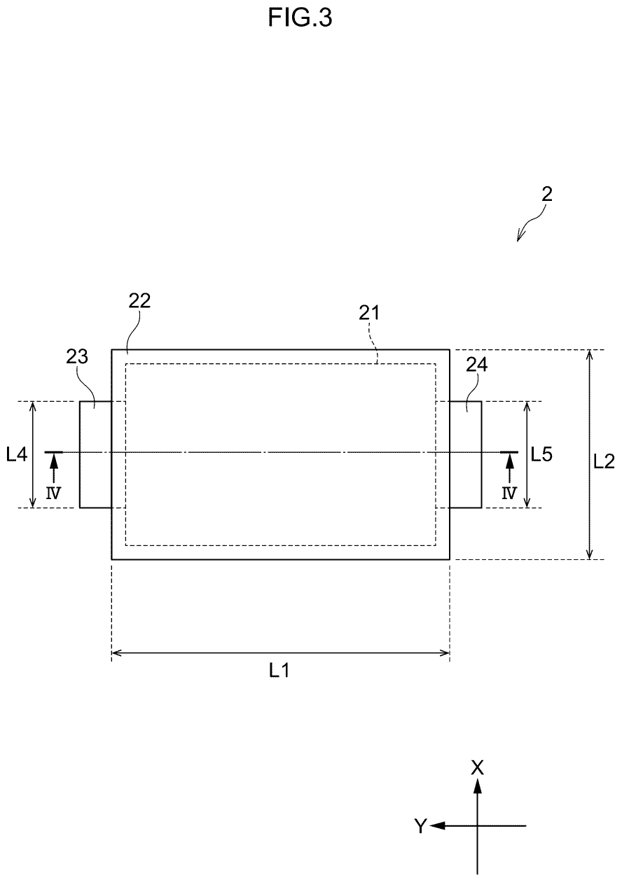

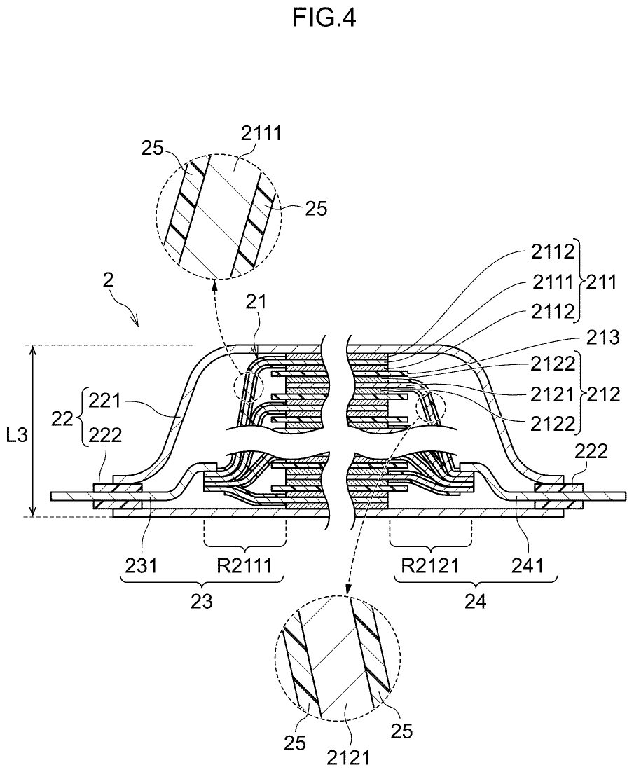

As shown in FIG. 2, plural batteries 2 are housed in an arrayed state in the module 1. In the present embodiment, twenty-four batteries 2 are arranged along the Z-axis direction. Adjacent batteries 2 are adhered to each other. The details of the battery 2 will be described later with reference to FIGS. 3 and 4.

A flexible printed circuit board (Flexible Printed Circuit: FPC) 13 is arranged on the battery 2. The flexible printed circuit board 13 is formed in a band shape with the X-axis direction as a longitudinal direction, and thermistors 14 are provided at both ends of the flexible printed circuit board 13. In the module 1, the thermistor 14 is not adhered to the battery 2, and is pressed toward the battery 2 side by the case lid 102.

One or more cushioning materials (not illustrated) are housed inside the module 1. For example, the cushioning material is a thin plate-shaped member which is elastically deformable, and is arranged between adjacent batteries 2 with the arrangement direction of the batteries 2 as its thickness direction. In the present embodiment, as an example, cushioning materials are arranged at both end parts in the longitudinal direction of the module 1 and at a central part in the longitudinal direction, respectively.

### (2) Battery

As shown in FIG. 3, the battery 2 includes an electrode body 21, a laminate exterior body 22, a positive electrode tab 23, a negative electrode tab 24, a nonaqueous electrolyte (not shown), and plural electrically insulating layers 25. The battery 2 has a rectangular parallelepiped shape.

The laminate exterior body 22 houses the electrode body 21, the nonaqueous electrolyte, and the plural electrically insulating layers 25. The positive electrode tab 23 protrudes from the laminate exterior body 22 in the Y-axis positive direction. The negative electrode tab 24 protrudes from the laminate exterior body 22 in the Y-axis negative direction.

The length L1 of the battery 2 in the Y-axis direction (see FIG. 3) is, for example, 530 mm to 600 mm. The length L2 of the battery 2 in the X-axis direction (see FIG. 3) is, for example, 80 mm to 110 mm. The length L3 of the battery 2 in the Z-axis direction (see FIG. 4) is, for example, 7.0 mm to 9.0 mm.

### (2.1) Electrode Body

The structure of the electrode body 21 is layer-type. As shown in FIG. 4, the electrode body 21 includes plural positive electrode sheets 211, plural negative electrode sheets 212, and plural separator sheets 213. In the electrode body 21, a positive electrode sheet 211 and a negative electrode sheet 212 are alternately layered along the Z-axis direction via a separator sheet 213.

The number of each of the positive electrode sheet 211, the negative electrode sheet 212, and the separator sheet 213 is not particularly limited, and is appropriately selected in accordance with the use of the battery 2.

### (2.1.1) Positive Electrode Sheet

The positive electrode sheet 211 has a positive electrode current collector 2111 (for example, aluminum foil or the like) and a positive electrode active material layer 2112 supported on both surfaces of the positive electrode current collector 2111. The positive electrode active material layer 2112 contains a positive electrode active material. The positive electrode active material releases lithium ions into, or occludes lithium ions from, the nonaqueous electrolyte. The positive electrode active material may be a known positive electrode active material (for example, LiNiO₂ or LiNi_{1/3}Co_{1/3}Mn_{1/3}O₂). The positive electrode active material layer 2112 may further contain a known conductive material (for example, carbon black), trilithium phosphate, and a known binder (for example, polyvinylidene fluoride).

### (2.1.2) Negative Electrode Sheet

The negative electrode sheet 212 has a negative electrode current collector 2121 (for example, copper foil or the like) and a negative electrode active material layer 2122 supported on both surfaces of the negative electrode current collector 2121. The negative electrode active material layer 2122 contains a negative electrode active material. In conjunction with charging and discharging, the negative electrode active material occludes lithium ions, which are charge carriers, from the nonaqueous electrolyte and releases them into the nonaqueous electrolyte. The negative electrode active material may be any known negative electrode active material (such as artificial graphite or lithium-alloy (for example, LiXM, in which M is C, Si, Sn, Sb, Al, Mg, Ti, Bi, Ge, Pb or P, and X is a natural number)). The negative electrode active material layer 2122 may further contain a known binder (for example, a styrene-butadiene copolymer).

### (2.1.3) Separator Sheet

The separator sheet 213 electrically insulates the positive electrode sheet 211 and the negative electrode sheet 212, and provides a lithium ion transfer path between the positive electrode active material layer 2112 and the negative electrode active material layer 2122. Examples of the separator sheet 213 include a porous film. Examples of the material of the porous film include polyethylene and polypropylene. The separator sheet 213 may have a single-layer structure or a multilayer structure.

### (2.2) Laminate Exterior Body

The laminate exterior body 22 covers the electrode body 21 and seals the electrode body 21 and the nonaqueous electrolyte together with the positive electrode tab 23 and the negative electrode tab 24. In the present embodiment, the laminate exterior body 22 has a single-cup structure (see FIG. 4). A “laminate exterior body having a single cup structure” refers to a single laminate exterior body having a bending line, one cup part (i.e., a recess) capable of housing the entire electrode body, and a flat part, in which, by bending along the bending line, the flat part covers the recess. The laminate exterior body 22 has a laminate sheet 221 and plural tab films 222. Each of the plural tab films 222 is welded to the positive electrode tab 23 or the negative electrode tab 24 and to the laminate sheet 221.

The laminate sheet 221 has a metal layer, an inner resin layer, and an outer resin layer. The inner resin layer is layered on the surface of the metal layer on the side of the electrode body 21. The outer resin layer is layered on the surface of the metal layer at an opposite side from the side of the electrode body 21. The metal layer blocks gas (such as moisture or air) outside the battery 2 and inside the battery 2 from entering and leaving. The material of the metal layer is a metal (for example, aluminum). The inner resin layer electrically insulates the electrode body 21, the positive electrode tab 23, and the negative electrode tab 24 from the metal layer. The inner resin layer may contain a thermoplastic resin. The outer resin layer improves the durability of the laminate sheet 221. The outer resin layer may contain a thermoplastic resin. Examples of the thermoplastic resin of the inner resin layer and the outer resin layer respectively include olefinic resins (for example, polypropylene and polyethylene), polyvinyl chloride, and polyvinylidene chloride.

The tab film 222 has a function of electrically insulating the laminate sheet 221 from the positive electrode tab 23 and the negative electrode tab 24, and a function of connecting the laminate sheet 221 with the positive electrode tab 23 and the negative electrode tab 24. The tab film 222 contains a thermoplastic resin. Examples of the thermoplastic resin of the tab film 222 include the same resins as those exemplified as the thermoplastic resin of each of the inner resin layer and the outer resin layer.

### (2.3) Electrically Insulating Layers

The positive electrode current collector 2111 has a positive electrode lead part R2111, which is a component of the positive electrode tab 23. The negative electrode current collector 2121 has a negative electrode lead part R2121, which is a component of the negative electrode tab 24. In the present embodiment, the plural electrically insulating layers 25 are arranged on both surfaces of the positive electrode lead part R2111 and on both surfaces of the negative electrode lead part R2121.

The thickness of the electrically insulating layer is not particularly limited, and may be about two times that of at least one of alumina beads or zirconia beads (hereinafter, simply referred to as “beads”), and may be from about 2 μm to about 10 μm. In the present embodiment, the electrically insulating layer includes polyvinylidene fluoride (hereinafter, also referred to as “PVDF”) and beads, and may be formed from PVDF and beads. The volume ratio of PVDF to beads (i.e., volume of PVDF:volume of beads) may be 50:50 to 80:20, and may be 60:40. PVDF is an example of a binder. Beads are an example of an electrically insulating filler.

The electrically insulating layer may further comprise, in addition to PVDF, polyethylene (PE), polypropylene (PP), styrene butadiene rubber (SBR), or the like, and the electrically insulating layer may further contain, in addition to the beads, metal oxide beads (other than the beads), metal nitride beads, or the like. Examples of the metal oxide beads (other than the beads) include silica. Examples of the metal nitride beads include silicon nitride.

In the present embodiment, the average particle diameter of the beads is about 1 μm to about 5 μm. The “average particle diameter” refers to the particle size (particle size distribution D50, median diameter) corresponding to the cumulative 50% by volume from the particle side in a volume-based particle size distribution measured by a particle size distribution measuring apparatus based on laser light diffraction scattering.

### (2.4) Positive Electrode Tab

The positive electrode tab 23 is electrically connected to the plural positive electrode current collectors 2111. The positive electrode tab 23 has a metal sheet 231 and a positive electrode lead part R2111 of the positive electrode current collector 2111. The metal sheet 231 and the positive electrode lead part R2111 are electrically connected to each other. Examples of the material of the metal sheet 231 include a metal (for example, stainless steel (SUS)). The length L4 of the positive electrode tab 23 in the X-axis direction is, for example, 40 mm to 50 mm.

### (2.5) Negative Electrode Tab

The negative electrode tab 24 is electrically connected to the plural negative electrode current collectors 2121. The negative electrode tab 24 has a metal sheet 241 and a negative electrode lead part R2121 of the negative electrode current collector 2121. The metal sheet 241 and the negative electrode lead part R2121 are electrically connected to each other. Examples of the material of the metal sheet 241 include a metal (for example, stainless steel (SUS)). The length L4 of the negative electrode tab 24 in the X-axis direction is, for example, 40 mm to 50 mm.

### (2.6) Nonaqueous Electrolyte

The battery 2 includes a nonaqueous electrolyte. The nonaqueous electrolyte is housed in the laminate exterior body 22 together with the electrode body 21. It is sufficient that the nonaqueous electrolyte be a solution in which a support salt as an electrolyte (for example, LiPF₆) is dissolved or dispersed in a nonaqueous solvent (for example, ethyl carbonate). The nonaqueous electrolyte may contain various additives (for example, lithium bis (oxalato) borate).

### (3) Mechanism and Effect

As described with reference to FIGS. 1 to 4, the battery 2 includes the electrode body 21, the laminate exterior body 22, the positive electrode tab 23, the negative electrode tab 24, and the electrically insulating layer 25. The positive electrode current collector 2111 has a positive electrode lead part R2111, which is a component of the positive electrode tab 23. The electrically insulating layer 25 is arranged on the surface of the positive electrode lead part R2111. The electrically insulating layer 25 contains a binder and an electrically insulating filler.

As a result, even if the electrically insulating layer 25 is exposed to a high temperature and the thickness of the electrically insulating layer 25 decreases with time, the thickness of the electrically insulating layer 25 is less likely to become smaller than the average particle diameter of the electrically insulating filler. In other words, the function of the electrically insulating layer 25 of providing electrical insulation to the positive electrode lead part R2111 is unlikely to be degraded by heat. As a result, in the battery 2, the occurrence of short circuiting is suppressed.

As described with reference to FIGS. 1 to 4, in the battery 2, the binder contains polyvinylidene fluoride.

As a result, the capacity of the battery 2 is less likely to decrease than in a configuration in which the binder does not contain PVDF. Furthermore, the electrically insulating layer 25 of the battery 2 has excellent thermal stability as compared to a configuration in which the binder does not contain polyvinylidene fluoride.

As described with reference to FIGS. 1 to 4, in the battery 2, the electrically insulating filler contains at least one of alumina beads or zirconia beads.

As a result, in the battery 2, the occurrence of short circuiting is suppressed as compared to a configuration in which the electrically insulating filler does not contain alumina beads or zirconia beads.

As described with reference to FIGS. 1 to 4, in the battery 2, the average particle diameter of the electrically insulating filler is about 1 μm to about 5 μm.

As a result, the thickness of the electrically insulating layer 25 is unlikely to become large, and the thickness of the electrically insulating layer 25 is unlikely to become substantially less than 1 μm as a result of creep. As a result, in the battery 2, even if the thickness of the electrically insulating layer 25 is relatively small, the occurrence of short circuiting is more reliably suppressed.

As described with reference to FIGS. 1 to 4, the module 1 includes plural batteries 2 and a case 10.

### (4) Variant Examples

In the present embodiment, the binder comprises PVDF, but the present disclosure is not limited thereto. The binder may be PVDF-free. When the binder does not contain PVDF, examples of the binder include polyethylene, polypropylene, and styrene butadiene rubber.

In the present embodiment, the electrically insulating filler includes beads, but the present disclosure is not limited thereto, and does not need to include beads. When the electrically insulating filler does not contain beads, examples of the electrically insulating filler include silica and silicon nitride.

In the present embodiment, the average particle diameter of the electrically insulating filler is about 1 μm to about 5 μm, but the present disclosure is not limited thereto. The average particle diameter of the electrically insulating filler may be more than 5 μm or less than 1 μm.

In the present embodiment, the positive electrode tab 23 has the metal sheet 231 and the positive electrode lead part R2111 of the positive electrode current collector 2111, but the present disclosure is not limited thereto. The positive electrode tab 23 may be formed from the positive electrode lead part R2111 of the positive electrode current collector 2111.

In the present embodiment, the laminate exterior body 22 has a single-cup structure (see FIG. 4), but the present disclosure is not limited thereto. In the present disclosure, the laminate exterior body 22 may have a double-cup structure. A “double cup structure” refers to one laminate exterior body having a bending line, one first cup part (recessed part) capable of housing a part of the electrode body, and one second cup part (recessed part) capable of housing a part of the electrode body, in which, by bending along the bending line, the entire electrode body can be housed in a space formed by the first cup part and the second cup overlapping with each other.

In the present embodiment, the positive electrode tab 23 protrudes from the laminate exterior body 22 in the Y-axis positive direction, and the negative electrode tab 24 protrudes from the laminate exterior body 22 in the Y-axis negative direction, but the present disclosure is not limited thereto. In the present disclosure, the positive electrode tab 23 and the negative electrode tab 24 may protrude from the laminate exterior body 22 in the Y-axis positive direction or the Y-axis negative direction.

In the present embodiment, the number of batteries 2 housed in the module 1 is twenty-four, but the present disclosure is not limited thereto. The number of batteries 2 housed in the module 1 may be 23 or less, or may be 25 or more.

In the present embodiment, the use application of the battery 2 is a vehicle power supply, but the present disclosure is not limited thereto. In the present disclosure, the use application of the battery 2 may be, for example, a power supply for an information processing apparatus (for example, a personal computer, a smartphone, or the like), a power supply for electricity storage, or the like.

What is claimed is:

1. A battery, comprising:
a layer-type electrode body comprising a positive electrode sheet including a positive electrode current collector and a negative electrode sheet including a negative electrode current collector, the positive electrode sheet and the negative electrode sheet being alternately layered in a layering direction via a separator sheet;
a laminate exterior body accommodating the electrode body;
a positive electrode tab that projects from the laminate exterior body toward one side in a first direction orthogonal to the layering direction, and that is electrically connected to a plurality of the positive electrode sheets;
a negative electrode tab that projects from the laminate exterior body toward the one side or another side in the first direction, and that is electrically connected to a plurality of the negative electrode sheets; and
an electrically insulating layer, wherein:
the positive electrode current collector includes a positive electrode lead part, which is a component of the positive electrode tab,
the electrically insulating layer is disposed at a surface of the positive electrode lead part, and
the electrically insulating layer includes a binder and an electrically insulating filler.

2. The battery according to claim 1, wherein the binder includes polyvinylidene fluoride.

3. The battery according to claim 1, wherein the electrically insulating filler includes at least one of alumina beads or zirconia beads.

4. The battery according to claim 1, wherein an average particle diameter of the electrically insulating filler is from about 1 μm to about 5 μm.

5. A module, comprising:
the battery according to claim 1; and
a case accommodating a plurality of the batteries.
